(19) United States
(12) Patent Application Publication
(10) Pub. No.: US 2002/0127323 A1
(43) Pub. Date: Sep. 12, 2002

(54) Turkey bar-b-que and process for making

(76) Inventor: Louis J. Bunn, Virginia Beach, VA (US)

Correspondence Address: Louis Bunn, 5041 Rouse Drive, Virginia Beach, VA, 23462, US

(21) Appl. No.: 09/957,497

(22) Filed: Sep. 21, 2001

Related U.S. Application Data
(60) Provisional application No. 60/274,956, filed on Mar. 12, 2001.

(51) Int. Cl. A23L 1/238

(52) U.S. Cl. 426/589

(57) ABSTRACT

The invention is a turkey barbecue and a method of making the same. Turkey meat is combined with a heart-healthy combination of ingredients to produce a barbecue. The resulting barbecue has less fat than traditional barbecue and may be part of a healthy diet.

### BACKGROUND OF THE INVENTION

Many Americans eat pork barbecue. Pork is relatively high in fat and cholesterol. Recent studies have shown that lowering the fat and cholesterol intake in people without heart disease greatly reduces the risk of developing heart disease. In 1998, the results of the Air Force/Texas Coronary Atherosclerosis Prevention Study showed that cholesterol lowering in generally healthy people with average cholesterol levels reduced their risk for a first-time major coronary event by 37 percent.

Two main nutrients in foods eaten make a person's LDL (bad) cholesterol level go up: saturated fat which is found mostly in foods made from animals; and cholesterol which comes only from animal products. Saturated fat raises LDL-cholesterol levels more than anything else in a diet. Eating too much saturated fat and cholesterol is the main reason for high levels of cholesterol and a high rate of heart attacks in the United States. Reducing the amount of saturated fat and cholesterol eaten is a very important step in reducing blood cholesterol levels.

Since pork is high in fat and cholesterol, eating pork barbecue may increase the risk of getting heart disease. Moreover, a diet high in fat may increase the risk of becoming obese. An obese condition tends to further increase the risk of getting heart disease. Therefore, if the fat content in barbecue is reduced, Americans can enjoy barbecue without increasing the risk of heart disease and related complications.

### BRIEF SUMMARY OF THE INVENTION

The invention is a heart-healthy barbecue made from turkey meat. Turkey meat contains a significantly less amount of fat than pork. A comparison of 3 oz. servings of pork and turkey shows the differences in fat content between the different types of meat. For example, a broiled, lean pork loin chop has 9 grams of fat. While, a comparably sized slice of roasted turkey breast has only 1 gram of fat. Thus, a barbecue made of turkey has less fat and is therefore more healthy than one made of pork.

It is therefore an object of the present invention to provide a heart-healthy barbecue that does not significantly contribute to the creation of heart disease and associated problems.

Another object of the present invention is to provide a process for producing and making the turkey barbecue.

### DETAILED DESCRIPTION OF THE INVENTION

The turkey barbecue includes a mixture of turkey meat, salt, vinegar, capsicum, capsicum pepper, water, cayenne and crushed pepper. The mixture may be combined in different portions to the desired taste of the individual preparing the barbecue. Further, the portions of the mixture may be added either before or after the turkey meat has been cooked.

In a first embodiment, turkey meat is removed from the bone and placed in an oven safe container. Cartilage and fat is separated from the turkey meat. Approximately 18 pounds of turkey meat is de-boned. Meat from turkey necks is combined with meat from the body of the turkey. The meat is blended in a processor with salt, preferably 6 oz. of salt for every 38 pounds of turkey meat. Next, 32 oz. of vinegar, 2 oz. of capsicum and 2 oz. of crushed capsicum pepper are blended together and poured over the turkey meat. And, 8 oz. of water is poured over the blended ingredients and turkey meat. The turkey meat and blended ingredients are placed in the oven and cooked for 4 hours at 350° F. The turkey meat is then removed from the oven. The turkey meat is allowed to cool until it is cool enough to be handled. The cooling time may range from a few minutes to several minutes depending upon cooling conditions. Next, 14 oz. of vinegar, 0.5 oz. of cayenne, and 1 oz. of crushed pepper are blended together and mixed with the turkey meat. The light and dark meat should be blended well.

In a second embodiment, 38 pounds of turkey meat is mixed together with 6 oz. of salt, 32 oz. vinegar, 2 oz. of capsicum, 2 oz. of capsicum pepper and 8 oz. water. After pouring the mixture over the turkey, the turkey is cooked for four hours at 350° F. After removing it from the oven, the turkey meat is de-boned and chopped into small pieces. Non-meat materials, such as cartilage, fat and ligaments, should be separated from the meat. Next, 14 oz. of vinegar, 0.5 oz. of cayenne and 1 oz. of crushed pepper are mixed and added to 18 pounds of cooked turkey meat and blended well. Cooked meat from additional turkey necks may be used to increase the amount of dark meat for the finished product. Additional seasoning such as salt, pepper and Tabasco Sauce® may be added to the desired taste of the individual consuming the turkey barbecue.

1. A turkey barbecue comprising:
turkey meat;
salt;
vinegar;
capsicum;
capsicum pepper;
water;
cayenne; and,
crushed pepper.

2. The turkey barbecue of claim 1 wherein said turkey comprises between 90-95 percent by volume.

3. The turkey barbecue of claim 1 wherein said salt comprises between 0.75-1.25 percent by volume.

4. The turkey barbecue of claim 1 wherein said vinegar comprises between 4-5 percent by volume.

5. The turkey barbecue of claim 1 wherein said capsium comprises between 0.1-0.5 percent by volume.

6. The turkey barbecue of claim 1 wherein said capsium pepper comprises between 0.1-0.5 percent by volume.

7. The turkey barbecue of claim 1 wherein said cayenne comprises between 0.05-0.1 percent by volume.

8. The turkey barbecue of claim 1 wherein said crushed pepper comprises between 0.1-0.2 percent by volume.

9. A method for making turkey barbecue, comprising:
blending salt and turkey meat;
blending vinegar, capsicum and crushed capsicum pepper together;
pouring said vinegar, capsicum and crushed capsicum pepper over the salt and turkey meat;
pouring water over the turkey meat;
cooking the turkey meat for 4 hours at a temperature of 350° F.;
cooling the turkey meat;
blending vinegar, cayenne, and crushed pepper together; and
mixing the vinegar, cayenne, and crushed pepper with the turkey meat.
